(19) United States
(12) Patent Application Publication
(10) Pub. No.: US 2026/0045373 A1
(43) Pub. Date: Feb. 12, 2026

(54) INERTIAL CONFINEMENT FUSION REACTOR

(71) Applicant: Westinghouse Electric Company LLC, Cranberry Township, PA (US)

(72) Inventors: Edward J. Lahoda, Edgewood, PA (US); Jianwei Chen, Wexford, PA (US); Manuel Ignacio Gonzalez Portilla, Madrid (ES); Abdullahi Mada, Cranberry Township, PA (US)

(73) Assignee: Westinghouse Electric Company LLC, Cranberry Township, PA (US)

(21) Appl. No.: 19/364,528

(22) Filed: Oct. 21, 2025

Related U.S. Application Data
(63) Continuation-in-part of application No. 18/975,444, filed on Dec. 10, 2024.
(60) Provisional application No. 63/609,773, filed on Dec. 13, 2023.
(60) Provisional application No. 63/697,842, filed on Sep. 23, 2024.

(51) Int. Cl. G21B 1/11; G21B 1/03

(52) U.S. Cl. CPC G21B 1/11; G21B 1/03

(57) ABSTRACT

An inertial confinement fusion reactor comprising a chamber, a first coolant inlet, a coolant outlet, a flow shaper disposed within the chamber, and a second coolant inlet. The first coolant inlet is configured to receive and direct a first coolant into a reservoir defined between a chamber wall and an outer surface defined by the flow shaper. The first coolant is to overflow a top end of the flow shaper, flow along an inner surface defined by the flow shaper, and exit the reactor through the coolant outlet. The second coolant inlet is configured to dispense a second coolant in a plurality of predefined streams such that a central void region is defined between the plurality of predefined streams, the central void region positioned at least partially within the interior region defined by the flow shaper, and the second coolant is to exit the reactor through the coolant outlet.

### CROSS-REFERENCE TO RELATED APPLICATIONS

This application is a continuation-in-part of U.S. patent application Ser. No. 18/975,444, filed Dec. 10, 2024, which claims the benefit of U.S. Provisional Patent Application No. 63/609,773, filed Dec. 13, 2023, and U.S. Provisional Application No. 63/697,842, filed Sep. 23, 2024. The entire disclosures of the prior applications are hereby incorporated by reference in their entirety.

### FIELD

The present disclosure is generally related to nuclear power and, more particularly, is directed toward inertial confinement fusion reactors.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, an inertial confinement fusion reactor comprising a chamber, a first coolant inlet, a coolant outlet, a flow shaper, and a second coolant inlet is disclosed. The chamber having a chamber wall extending between an upper plate and a lower plate. The first coolant inlet is defined in the chamber wall. The flow shaper is disposed within the chamber. The flow shaper defines an interior region and the coolant outlet is positioned within the interior region. The first coolant inlet is configured to receive and direct a first coolant into a reservoir defined between the chamber wall and an outer surface defined by the flow shaper. The first coolant is to overflow a top end of the flow shaper, flow along an inner surface defined by the flow shaper, and exit the reactor through the coolant outlet. The second coolant inlet is configured to dispense a second coolant in a plurality of predefined streams such that a central void region is defined between the plurality of predefined streams, the central void region positioned beneath the second coolant inlet and at least partially within the interior region defined by the flow shaper. The second coolant is to exit the reactor through the coolant outlet.

In various aspects, an inertial confinement fusion reactor comprising a chamber, a coolant inlet, a coolant outlet, a flow shaper, and a coolant distributor is disclosed. The chamber having a chamber wall extending between an upper plate and a lower plate, the coolant inlet defined in the chamber wall. The flow shaper is disposed within the chamber. The flow shaper defines an interior region, and the coolant outlet is positioned within the interior region. The coolant inlet is configured to receive and direct reactor coolant into a reservoir defined between the chamber wall and an outer surface defined by the flow shaper. The reactor coolant is to overflow a top end of the flow shaper, flow along an inner surface defined by the flow shaper, and exit the reactor through the coolant outlet. The coolant distributor is configured to dispense reactor coolant in a plurality of predefined streams such that a central void region is defined between the plurality of predefined streams, the central void region positioned beneath the coolant distributor and at least partially within the interior region defined by the flow shaper. The reactor coolant flowing from the coolant distributor exits the reactor through the coolant outlet.

In various aspects, an inertial confinement fusion reactor comprising a chamber, a flow shaper, a coolant inlet, and a coolant distributor is disclosed. The chamber comprising a chamber wall extending between an upper plate and a lower plate. The flow shaper is disposed within the chamber, the flow shaper defining an interior region. The coolant inlet is to receive and direct reactor coolant into a reservoir defined between the chamber wall and an outer surface of the flow shaper. The reactor coolant is configured to overflow the flow shaper and flow along an interior surface of the flow shaper to a coolant outlet positioned within the interior region. The coolant distributor is configured to dispense reactor coolant in a plurality of predefined streams such that a central void region is defined between the plurality of predefined streams, the central void region positioned beneath the coolant distributor and at least partially within the interior region defined by the flow shaper. The reactor coolant flowing from the coolant distributor exits the reactor through the coolant outlet.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 is a graph of the neutron flux and tritium (³H) production within Li₂BeF₄(FLiBe) reactor coolant versus the distance from a fusion reaction zone in a fusion reactor;

FIG. 2 is a graph of the neutron flux and tritium (³H) production within 20% Lithium (Li)/80% Lead (Pb) reactor coolant versus the distance from a fusion reaction zone in a fusion reactor;

FIG. 3 is a graph of the neutron flux and tritium (³H) production within Lithium (Li) reactor coolant versus the distance from a fusion reaction zone in a fusion reactor;

FIG. 4 is a plan view schematic of a generic fusion reactor;

FIG. 5A is a front elevation view of a prior art fusion reactor;

FIG. 5B is a side elevation view of the prior art fusion reactor of FIG. 5A;

FIG. 6 is a cross-section elevation view of an inertial confinement fusion reactor;

FIG. 7 is a plan view of the inertial confinement fusion reactor of FIG. 6; and

FIG. 8 is a cross-section plan view of the inertial confinement fusion reactor for FIG. 6 taken through an annular trough portion of the inertial confinement fusion reactor;

FIG. 9 is a cross-section elevation view of an inertial confinement fusion reactor;

FIG. 10 is a cross-section elevation view of an inertial confinement fusion reactor;

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

In the following description, reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms.

Before explaining various aspects of the inertial confinement fusion reactor in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

In general, deuterium-tritium fueled fusion reactors provide most of their energy in the form of 14 MeV neutrons. In order for energy to be obtained from these high energy neutrons, they have to be slowed through elastic collisions with coolant materials. Further, the coolant materials absorb the neutrons to form tritium (³H). The tritium that is generated must be recovered in order for the reactor to be self-sustaining. Typically, Lithium (Li) and Beryllium (Be) are the primary absorbers of the neutrons and form tritium upon absorption of the neutrons. The thickness of the coolant materials required to absorb these neutrons depends on the coolant, as discussed in greater detail below.

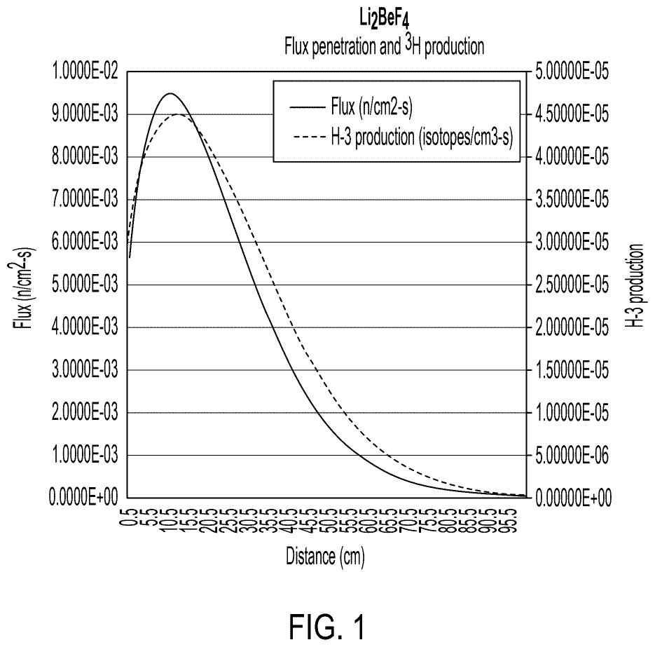

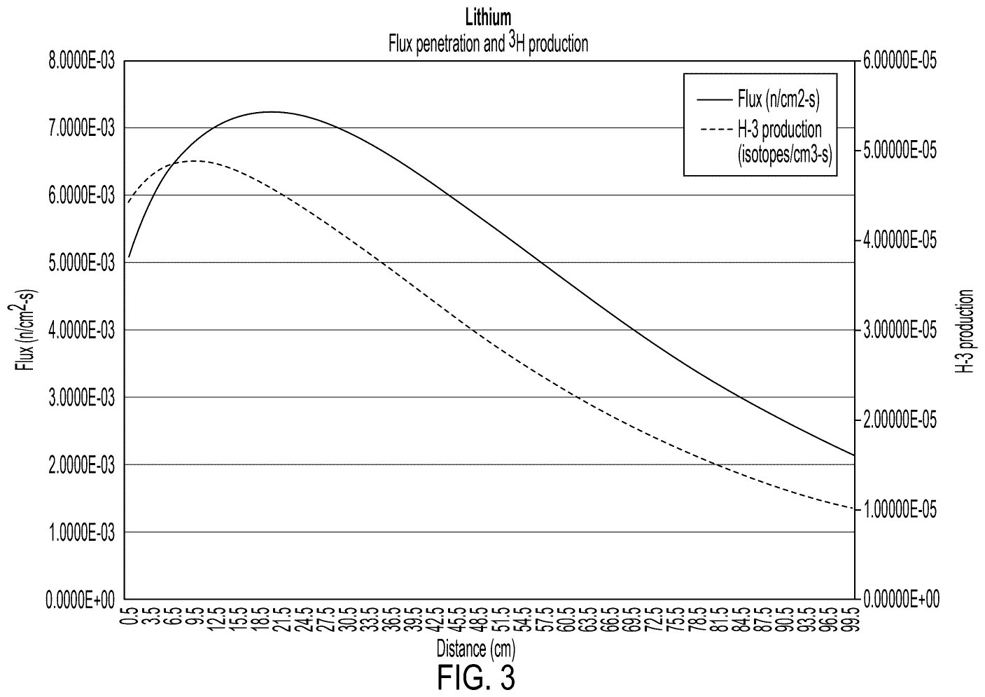

Table 1 below lists the minimum coolant thickness required to absorb 14 MeV neutrons for the three most common coolants which are Li, 20% Li/80% Pb, and Li2BeF4 (i.e., FLiBe). Specifically, the thickness required for Lithium is 150 cm, the thickness required for Li2BeF4 is 92 cm, and the thickness required for 20% Li/80% Pb is 40 cm. The thickness required shown in Table 1 is derived from the graphs illustrated in FIGS. 1-3. Specifically, FIGS. 1-3 illustrate the neutron flux and tritium (3H) production for different coolant materials (i.e., Li2BeF4, 20% Li/80% Pb, and Lithium) versus the distance from the fusion reaction zone of a fusion reactor.

Further to the above, as shown in FIG. 1, the neutron flux is essentially zero in Li₂BeF₄ coolant when the distance from the reaction zone is ˜92 cm. As such at least 92 cm thick of Li₂BeF₄ coolant is required to stop a 14 MeV neutron from a fusion reaction from passing through the coolant. In other words, the coolant thickness required directly corresponds to the distance from the fusion reaction at which the neutron flux is essentially zero (i.e., the stopping distance). The stopping distances require that the liquid coolant selected maintain at least the required thickness and density at all reactor wall locations to minimize degradation of the walls of the reactor. In addition, the stopping distances promote the production of tritium by reducing parasitic absorption of neutrons in the walls of the reactor, as discussed in greater detail herein.

TABLE 1

| | | | | | | Thickness | Weight of | Solid Thermal | Melting | Cp |
|---|---|---|---|---|---|---|---|---|---|---|
| | | | | | | required | Thickness | Conductivity | Point | (cal/gm/ |
| Material | Moles | MW | % wgt | g/cm³ | g/cm3 | (cm) | (gm/cm2) | (W/m-K) | (° C.) | ° C.) |
| Pb | | 207.2 | 0.8 | 11.35 | 9.08 | | | | | 0.0305723 |
| Li | | 6.94 | 0.2 | 0.534 | 0.1068 | | | | | 0.833333 |
| | | | | | 9.2 | 40 | 367 | 0.090 | 235 | 0.19112444 |
| Li₂BeF₄ | | | | | | | | | | 0.576574 |
| F | 4 | 19 | 0.77 | | 1.58 | | | | | |
| Li | 2 | 6.94 | 0.14 | | 0.29 | | | | | |
| Be | 1 | 9.01 | 0.09 | | 0.19 | | | | | |
| | | 98.89 | 1.00 | | 2.05 | 92 | 189 | 1.000 | 460 | |
| Li | | 6.94 | | | 0.534 | 150 | 80 | 85.000 | 181 | 0.833333 |
| 304L | | | | | | | | 15.000 | | |

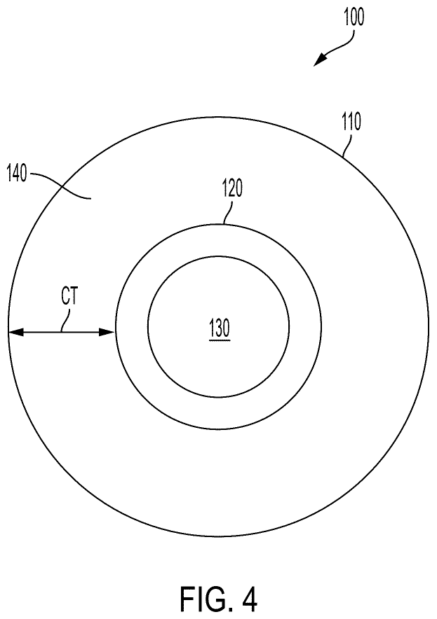

Further to the above, if the reactor coolant is a liquid, the coolant must be contained within a vessel that has an internal thickness of at least the stopping distance discussed above. Many fusion concepts utilize a first wall that is the boundary between the fusion reaction zone and the coolant. Referring primarily to FIG. 4, a generic fusion reactor 100 comprising a rear wall 110 with heat transfer components, a first wall 120, a fusion reaction zone 130, and a coolant 140 having a coolant thickness CT is positioned between the first wall 120 and the rear wall 110. In at least one common approach to building a fusion reactor power plant, such as the fusion reactor 100, the coolant 140 is kept molten and is circulated to the heat transfer components. Further, as can be seen in FIG. 4, the first wall 120 surrounds the fusion reaction zone 130. As such, the first wall 120 materials have very limited lifetimes in an environment producing 14 MeV neutrons (i.e., from the fusion reaction zone 130). In general, the expected lifetimes of most materials for the first wall 120 is on the order of months after which the reactor vessel would have to be rebuilt and the highly activated (e.g., irradiated) materials that form the first wall 120 would need disposed. Moreover, this work would have to be performed in a highly radioactive environment.

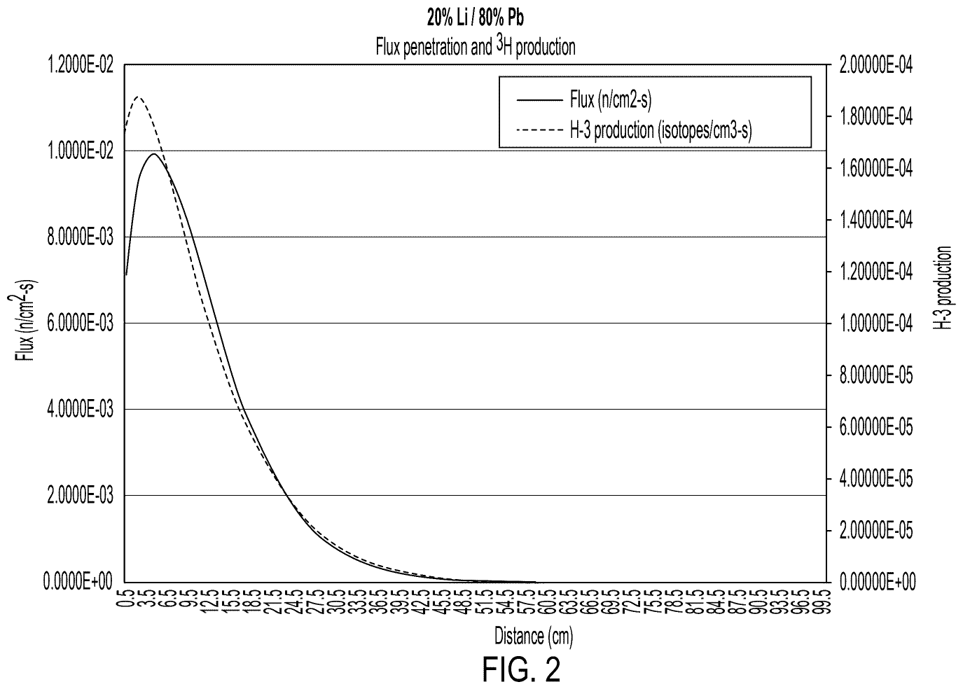

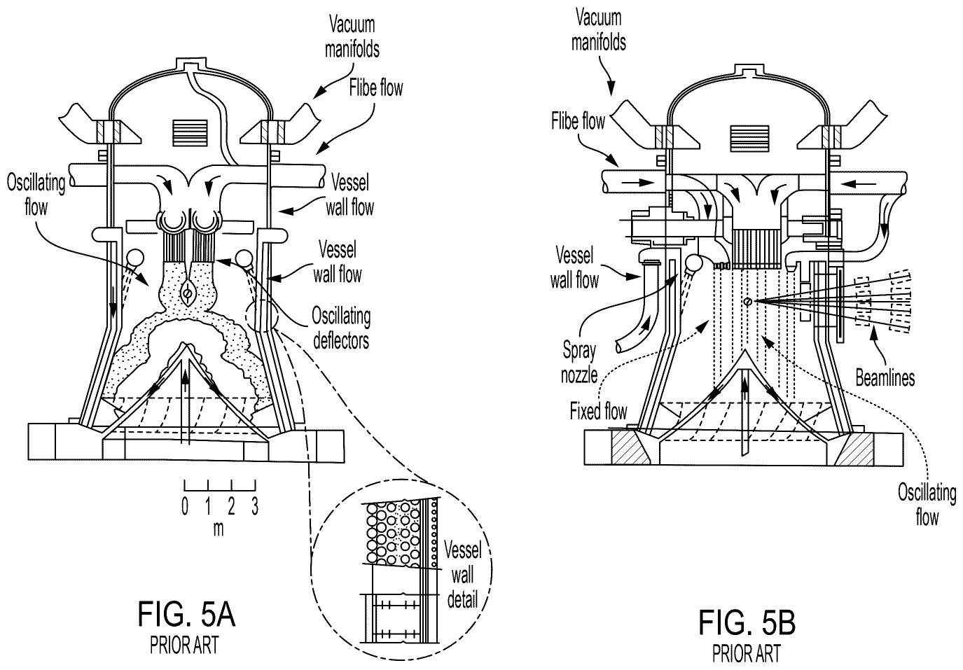

An alternative fusion reaction would be to eliminate the first wall 120 discussed above and have a liquid interface with the fusion reaction (i.e., with the reaction zone 130). This concept has been put forward in the HYLIFE concept by the Lawrence Livermore Laboratory (“The High-Yield Lithium-Injection Fusion-Energy (HYLIFE) Reactor,” UCRL-53559, DE86 006996) and (“HYLIFE-11: A MOLTEN-SALT INERTIAL FUSION ENERGY POWER PLANT DESIGN-FINAL REPORT,” Fusion Technology, Vol 25, January 1994.) These concepts depend on waterfalls of coolant to moderate and absorb the neutrons as shown in FIGS. 5A and 5B which have been reproduced from FIG. 2 of HYLIFE-11: A MOLTEN-SALT INERTIAL FUSION ENERGY POWER PLANT DESIGN-FINAL REPORT. One issue with this approach is that as the coolant stream falls along the reactor and reaction zone, the cross-section thickness and/or density of the liquid wall between the reaction zone and the reactor wall will decrease as the coolant velocity increases due to gravity. In other words, the cross-section thickness and/or density of the coolant at the top of the reactor will be greater than the cross-section thickness and/or density of the coolant at the bottom of the reactor due to the coolant moving at a greater speed at the bottom of the reactor due to gravity as compared to the top of the reactor. Further, using individual nozzles, as shown in FIG. 5B, leaves spacing between the falling streams of coolant which further decreases the cross-section density of the coolant. As such, this approach requires very large coolant flowrates in order to maintain the liquid curtain density all the way to the bottom of the reactor. Higher flow rates will require more pumping power increasing the parasitic power loads for the plant and reducing the output of the power plant.

Further to the above, a nuclear fusion reaction typically results in two forms of radiation being released, namely gamma x-rays and neutrons. In particular, neutrons from any deuterium-tritium (DT) fusion reaction carry ˜70% of the energy, and the gamma x-rays carry ˜20% of the energy. Further, alpha particles emitted from the reaction share their energy with the fuel along with debris and which makes up ˜10% of the energy. For an inertial confinement fusion reactor such as with the HYLIFE blanket system, discussed above, a multitude of flow streams form a waterfall is designed to absorb the energy from these three product streams. The blanket of streams (e.g., coolant) must be thick enough to absorb all the high energy neutrons to protect the first wall of the chamber and produce enough tritium to maintain the fusion reaction. As a result, the flowrate of the blanket of streams, which are controlled by gravity, must be very high in order for each neutron to be fully absorbed by the coolant. With the waterfall approach, such as in the HYLIFE blanket system, this may result in not only a very high coolant flowrate but also a very large reactor since the coolant flow in the waterfall may make up only 50% to 60% of the volume of the reactor chamber. The waterfall of individual streams concept was developed for the blanket primarily in response to a phenomenon called isochoric expansion or, the “hammer wall”. This is more aggressive when faced with a solid wall of salt instead of individual streams.

Further to the above, neutrons, x-rays, and debris will all impact the blanket differently. Neutrons will be absorbed throughout the full width of the coolant. The x-rays and debris will be absorbed on the inner surface of the coolant. X-ray deposition occurs with a penetration depth of ˜100 microns and, thus, only a thin layer of coolant may be needed to achieve full absorption. The debris is mostly consumed by other effects before it reaches the coolant and, due to plasma heating, produces a shockwave that evaporates, or explodes, the coolant. In a reactor where there is a large dense wall of coolant, such as in the HYLIFE blanket system, the net force would be strong outwards and would apply large forces on the walls of the chamber containing the coolant due to the shockwaves produced during the fusion reaction. As such, it may be advantageous to design an inertial confinement fusion reactor with smaller streams spaced three hundred and sixty degrees around the reaction zone such that the smaller streams explode uniformly outwards relative to themselves. In such instances, due to the location of the streams, these explosions will occur into each other and cancel out. As such, this may result in a lower net force outward. Further, it may be advantageous to design an inertial confinement fusion reactor that is a hybrid of individual waterfall streams surrounding the fusion reaction zone which are backed up by a thin layer of flowing coolant whose shape is defined by a first wall to minimize the flow, further backed up by a flow chamber designed to maximize the absorption of neutrons to maximize tritium generation. Solutions to the above-described problems with current fusion reactor designs are discussed in greater detail below.

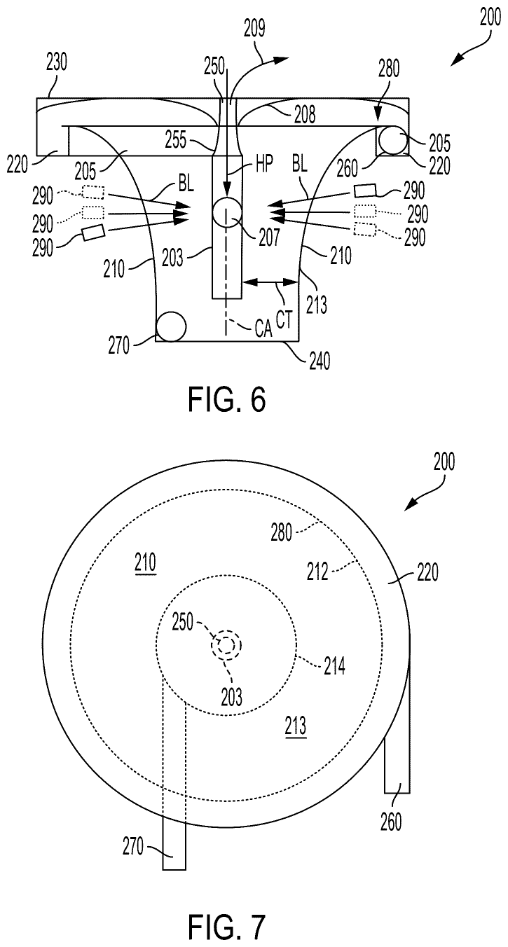

FIGS. 6-8 illustrate an inertial confinement fusion reactor 200 comprising a first wall 210 (e.g., a flow shaper, a funnel portion, or a reactor vessel wall), an annular trough 220 (e.g., an annular well or an annular distribution channel) extending from the first wall 210 at a top portion thereof, an upper plate 230, a lower plate 240, and a diverter 250 extending downward from the upper plate 230 and centrally positioned within the fusion reactor 200. The fusion reactor 200 defines a central axis CA as shown in FIG. 6. The diverter 250 defines an arcuate profile 255 to direct the coolant flow away from the central axis CA.

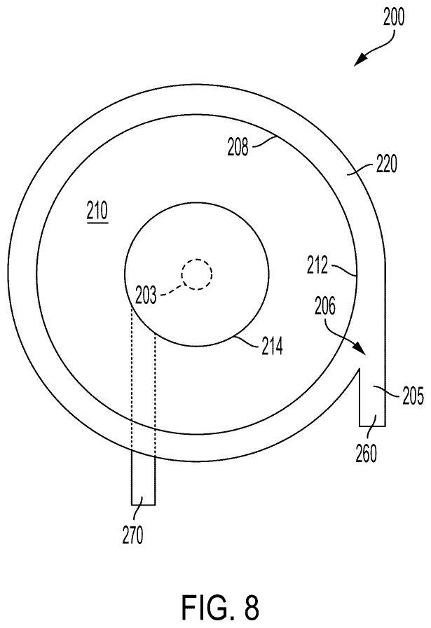

Further to the above, the fusion reactor 200 comprises a coolant inlet 260 coupled to the annular trough 220, a coolant outlet 270 at a lower portion of the fusion reactor 200, and a weir 280 positioned intermediate the annular trough 220 and the first wall 210. In use, coolant 205 enters the annular trough 220 through the coolant inlet 260 and is circulated around the annular trough 220. Specifically, referring to FIG. 8, the coolant 205 enters into the trough 220 through an opening 206. The coolant 205 flows within the annular trough 220 in a centrifugal manner (e.g., circular flow) until the coolant 205 speed and/or amount increases such that the coolant 205 overflows the weir 280 onto the first wall 210. Further, as the reactor coolant 205 overflows the weir 280 onto the first wall 210, the coolant 205 is still moving in a tangential manner in the region of the first wall 210 and eventually exits the first wall 210 through the coolant outlet 270 at the bottom of the fusion reactor 200. As such, after exiting the annular trough 220, the coolant 205 flows in a centrifugal manner and downward along the entire height of the first wall 210 until the coolant 205 exits through the coolant outlet 270. In at least one aspect, the coolant 205 is evenly distributed as centrifugal flow onto the first wall 210 after exiting the annular trough 220.

Further to the above, as more of the coolant 205 is flowed into the fusion reactor 200 and overflows the weir 280, the coolant 205 will come into contact with the diverter 250 and be directed downward and away from the central axis CA of the fusion reactor 200 by the arcuate profile 255 of the diverter 250. Further, once the flow of the coolant 205 is constant (e.g., constant volumetric flow) within the fusion reactor 200, a central void region 203 (e.g., a central cavity) devoid of coolant 205 is formed below the diverter 250 due to the tangential nature of the flow of the coolant 205 and the arcuate profile 255 of the diverter 250. In other words, when the flow of the coolant 205 is constant, there is no coolant 205 within the central void region 203. The circular flow pattern (e.g., centrifugal flow) of the coolant 205 will maintain the central void region 203 within which a fusion reaction can be initiated and sustained, as discussed in greater detail below.

Further to the above, the fusion reactor 200 further comprises a Hohlraum injector to inject a Hohlraum pellet (e.g., a fuel pellet) into the central void region 203 within the reactor coolant 205 when the flow of the reactor coolant 205 is constant within the fusion reaction 200. In at least one aspect, the Hohlraum injector is housed within and/or injects the pellet through the diverter 250 in the direction of arrow HP shown in FIG. 6. Further, the fusion reactor 200 comprises a plurality of lasers 290 which are to direct energy along beamlines BL at the Hohlraum pellet when the Hohlraum pellet is injected into the central void region 203. In at least one aspect, the lasers 290 may be at the bottom of the fusion reactor 200 and direct energy upward at the Hohlraum pellet. In at least one aspect, the lasers 290 may be positioned at the bottom and sides of the central void region 203. In any event, the lasers 290 direct energy along the beamlines BL to intercept the injected pellet from the Hohlraum injector as the pellet falls into the paths of the lasers 290. Upon the laser beams intercepting the pellet, a fusion reaction begins within the central void region 203. The fusion reaction is represented by a reaction zone 207 illustrated in FIG. 6. In at least one aspect, when a fusion reaction is sustained in the reaction zone 207, a liquid gas interface 208 forms between the coolant 205 and exhaust gasses 209 in the fusion reactor 200, see FIG. 6.

Further to the above, during the fusion reaction, the coolant 205 flowing around the central void region 203 intercepts the neutrons from the reaction zone 207. The amount of coolant 205 between the reaction zone 207 and/or the central void region 203 and the first wall 210 can be optimized to prevent the neutrons produced by the fusion reaction from reaching the first wall 210, no matter the elevation within the fusion reactor 200, as discussed in greater detail below.

The first wall 210 defines an upper diameter 212 and a lower diameter 214 that is smaller than the upper diameter 212. The first wall 210 defines an arcuate profile 213 (see FIG. 6) between the upper diameter 212 and the lower diameter 214. In various aspects, the arcuate profile 213 of the first wall 210 is selected and/or optimized to ensure that coolant thickness CT (see FIG. 6) between the central void region 203 and the first wall 210 at every elevation along the height of the fusion reactor 200 is such that the neutron flux at the first wall 210 is zero, or substantially close to zero, as the fusion reaction is sustained, as discussed in greater detail below.

The above-described centrifugal flow of the coolant 205 over the weir 280 onto the first wall 210 provides a constant volume flow along the entire height of the fusion reactor 200 as the downward flow of the coolant 205 increases. Table 2 below illustrates that the reactor diameter (i.e., the diameter of the first wall 210) must change with height to maintain a constant volume of flow for a minimum total flow rate.

TABLE 2

| Minimum coolant thickness | 1 | m | Based on the absorption calculations for FLIBE | | | |
|---|---|---|---|---|---|---|
| Reaction chamber diameter | 0.5 | m | Assumed | | | |
| Minimum reactor diameter | 2.5 | m | | | | |
| Minimum flow area | 4.71 | m2 | | | | |
| Delta P in HX | 30 | psi | | | | |
| Delta P in piping | 30 | psi | | | | |
| Steam temperature | | C. | | | | |
| FLiBe temperature | | C. | | | | |
| Heat transfer coefficient boiling | | | | | | |
| Heat transfer coefficient superheat | | | | | | |
| FLiBe temperature from reactor | | C. | | | | |
| Vapor pressure of FLiBe | | torr or mm Hg | | | | |
| Height on 3 m reactor | 0.1 | 0.5 | 1 | 2 | 3 | m |
| Time for coolant to fall | 0.143 | 0.319 | 0.452 | 0.639 | 0.782 | s |
| Maximum velocity of coolant | 1.40 | 3.13 | 4.43 | 6.26 | 7.67 | m/s |
| Flow area | 25.80 | 11.54 | 8.16 | 5.77 | 4.71 | m2 |
| Reactor diameter | 5.75 | 3.87 | 3.26 | 2.76 | 2.50 | m |
| Reactor radius | 2.88 | 1.93 | 1.63 | 1.38 | 1.25 | m |
| Coolant flow rate | 36.12 | 36.12 | 36.12 | 36.12 | 36.12 | m3/s |
| Coolant flow rate | 72332 | 72332 | 72332 | 72332 | 72332 | kg/s |
| Power required | 21090 | 21090 | 21090 | 21090 | 21090 | kcal/s |
| Temperature rise | 0.51 | 0.51 | 0.51 | 0.51 | 0.51 | ° C. |

Further to the above, the equations used to derive the reactor diameter results in Table 2 are shown below.

$$V = gt ( g = gravitational constant , t is time , and v is velocity ) S = 0.5 gt \hat{} 2 ( s is height of reactor )$$

$$t = ( 2 s / g ) \hat{} 0.5 ( solving for t )$$

$$v = ( 2 sg ) \hat{} 0.5 ( solving for v and substituting for t )$$

$$flow area = A = {( D \hat{} 2 - d \hat{} 2 )}^{*} 3.14 / 4 ( D is the outer diameter of the reactor vessel , d = the diameter of the reaction chamber )$$

$$minimum flow = f = ( 2 sg ) \hat{} {\text{.5}}^{*} {( D \hat{} 2 - d \hat{} 2 )}^{*} 3.14 / 4 ( flow at the bottom of the reactor vessel - narrowest point )$$

$$diameter of the reactor as a function of distance ( x ) from the top of the reactor = ( f / [ ( 2 gx ) \hat{} {\text{.5}}^{*} 3.14 / 4 ] + d \hat{} 2 ) \hat{} 0.5$$

The reactor diameters generated from the above-described equations can be utilized to define the arcuate profile 213 of the first wall 210 to optimize the performance of the fusion reactor 200. Specifically, the arcuate profile 213 of the first wall 210 selected will directly affect the amount of coolant 205 between the central void region 203 where the fusion reaction occurs and the first wall 210. As such, the arcuate profile 213 and coolant 205 can be selected to maximize the absorption of neutrons from the fusion reaction and maximize the generation of tritium produced. In at least one aspect, the arcuate profile 213 and coolant 205 can be selected to minimize the total coolant flow that is required to maintain a minimum coolant wall thickness.

Further to the above, the above-described inertial confinement fusion reactor 200 protects a structural rear wall from neutrons to allow for long periods of operation before having to be replaced. Further, the use of the annular trough 220 and the weir 280 decreases the materials that are exposed to the neutron irradiation. In at least one aspect, only the diverter 250 may be exposed to high levels of neutron irradiation. In at least one aspect, the diverter 250 is replaceable.

Further to the above, the coolant 205 may be of the types described herein. In various aspects, the coolant 205 may be selected from the group of lithium, lead, FLiBe, and combinations thereof.

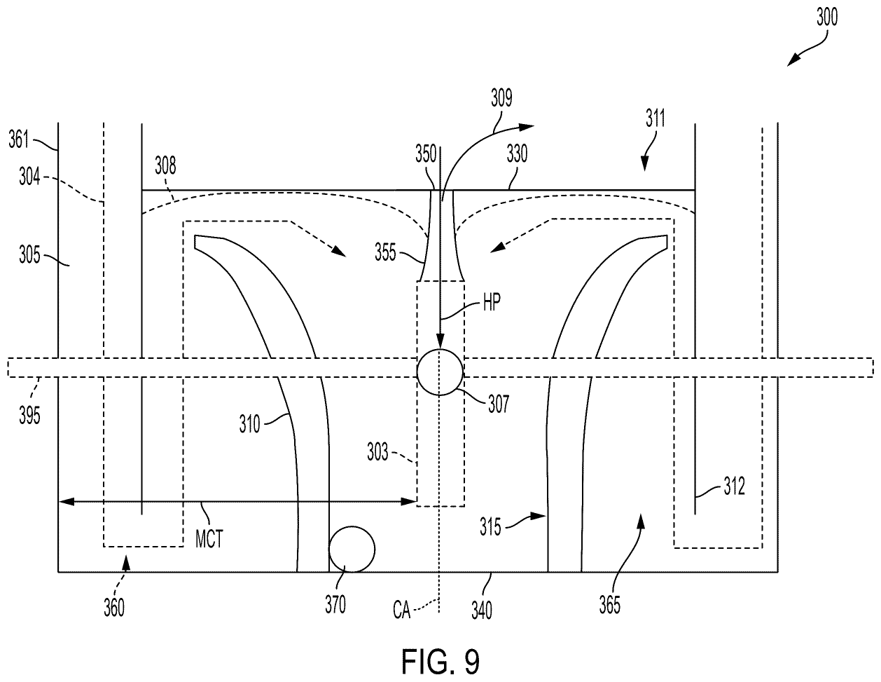

FIG. 9 illustrates an additional embodiment of an inertial confinement fusion reactor 300 comprising a flow shaper 310 (e.g., a funnel portion or a reactor vessel interior structure) configured to shape a flow 304 of coolant 305 within a chamber 311. The chamber 311 comprises an upper plate 330, a lower plate 340, and a chamber wall 312 extending between the upper plate 330 and the lower plate 340. The fusion reactor 300 further comprises a diverter 350 extending downward from the upper plate 330 and centrally positioned within the fusion reactor 300. The fusion reactor 300 defines a central axis CA as shown in FIG. 9. The diverter 350 defines an arcuate profile 355 to direct a flow 304 of a coolant 305 away from the central axis CA. In at least one aspect, the diverter 350 is replaceable.

Further to the above, the fusion reactor 300 comprises a coolant inlet 360 coupled to the chamber wall 312 and a coolant outlet 370 at a lower portion of the fusion reactor 300. In use, coolant 305 enters the chamber 311 through the coolant inlet 360 and fills a reservoir 365 (e.g., a space between the flow shaper 310 and the chamber wall 312). The inlet 360 may be positioned at any height along the chamber wall 312. In addition, coolant 305 may be provided to the inlet 360 via an inlet channel 361. In the non-limiting example of FIG. 9, the fusion reactor 300 includes a vertical inlet channel 361 surrounding the chamber wall 312. In this example, the flow 304 of the coolant 305 travels downwards through the inlet channel 361 and enters the chamber 311 through an inlet 360 provided along a lower end of the chamber wall 312.

In at least one aspect, the coolant 305 is introduced to the inlet channel 361 or to the chamber 311 through the inlet 360 in a tangential manner. Upon entering the chamber 311 through the inlet 360, the coolant 305 fills the reservoir 365 between the chamber wall 312 and the flow shaper 310 while continuing to flow in a tangential manner. As coolant 305 is continually supplied to the chamber 311 a level of the coolant 305 in the reservoir 365 increases such that the coolant 305 overflows the top end of the flow shaper 310 onto an interior surface 315 of the flow shaper 310. Further, as the reactor coolant 305 overflows the top end of the flow shaper 310, the coolant 305 is still moving in a tangential manner in the interior region of the flow shaper 310 and eventually exits the flow shaper 310 through the coolant outlet 370 at the bottom of the chamber 311. As such, after overflowing the top end of the flow shaper 310, the coolant 305 flows in a centrifugal manner and downward along the entire height of the interior surface 315 of the flow shaper 310 until the coolant 305 exits through the coolant outlet 370. In at least one aspect, the coolant 305 is evenly distributed as centrifugal flow onto the interior surface 315 of the flow shaper 310 after overflowing the top end of the flow shaper 310.

Further to the above, as more of the coolant 305 is flowed into the chamber 311 and overflows the top end of the flow shaper 310, the coolant 305 will come into contact with the diverter 350 and be directed downward and away from the central axis CA of the fusion reactor 300 by the arcuate profile 355 of the diverter 350. Further, once the flow 304 of the coolant 305 is constant (e.g., constant volumetric flow) within the fusion reactor 300, a central void region 303 (e.g., a central cavity) devoid of coolant 305 is formed below the diverter 350 due to the arcuate profile 355 of the diverter 350. In other words, when the flow 304 of the coolant 305 is constant, there is no coolant 305 within the central void region 303.

Further to the above, the fusion reactor 300 further comprises a Hohlraum injector to inject a Hohlraum pellet (e.g., a fuel pellet) into the central void region 303 within the reactor coolant 305 when the flow 304 of the reactor coolant 305 is constant within the fusion reaction. In at least one aspect, the Hohlraum injector is housed within and/or injects the pellet through the diverter 350 in the direction of arrow HP shown in FIG. 9. Further, the fusion reactor 300 comprises a plurality of laser beam injector ports 395 that permit a plurality of lasers disposed exterior to the chamber 311 to direct energy through the laser beam injector ports 395 at the pellet when the pellet is injected into the central void region 303. In at least one aspect, the laser beam injector ports 395 may extend horizontally and be positioned at a height similar to the pellet such that energy from the lasers may be directed horizontally at the pellet. In at least one aspect, the laser beam injector ports 395 may extend vertically or diagonally towards the pellet. In at least one aspect, the laser beam injector ports 395 may extend through the flow shaper 310, the chamber wall 312, and/or the inlet channel 361. In any event, the lasers direct energy through the laser beam injector ports 395 to intercept the injected pellet from the Hohlraum injector as the pellet falls into the paths of the laser beam injector ports 395. Upon the laser beams intercepting the pellet, a fusion reaction begins within the central void region 303. The fusion reaction is represented by a reaction zone 307 illustrated in FIG. 9. In at least one aspect, when a fusion reaction is sustained in the reaction zone 307, a liquid gas interface 308 forms between the coolant 305 and exhaust gasses 309 in the fusion reactor 300.

Further to the above, during the fusion reaction, the coolant 305 flowing within the chamber 311 intercepts the neutrons from the reaction zone 307. The width of the chamber 311, and thus the amount of coolant 305 between the reaction zone 307 and/or the central void region 303 and the chamber wall 312 can be optimized to prevent the neutrons produced by the fusion reaction from reaching the chamber wall 312. That is, in at least one aspect, the distance from the chamber wall 312 to the reaction zone 307 and/or the central void region 303 may be equal to or greater than a minimum coolant thickness MCT required to absorb the produced neutrons. In at least one aspect, and as depicted in FIG. 9, the distance from an outer wall of the inlet channel 361 to the reaction zone 307 and/or the central void region 303 may be equal to or greater than the minimum coolant thickness MCT required to absorb the produced neutrons.

Since the embodiment of FIG. 9 relies on the coolant 305 exterior of the flow shaper 310 to absorb neutrons produced during a fusion reaction, the thickness of the coolant 305 within the interior region of the flow shaper 310 is significantly less than the minimum coolant thickness MCT. Thus, the pumping requirements required by the embodiment of FIG. 9 are less than those required by the embodiment of FIG. 6.

Further to the above, unlike the chamber wall 312, the flow shaper 310 is not considered as a structural member of the fusion reactor 300 (i.e., providing structural support). As such, the flow shaper 310 may be formed of a material that is lighter and/or thinner than structural members of generic reactors. In at least one aspect, the material of the flow shaper 310 may also include a low neutron absorption coefficient to minimize parasitic neutron absorption and activation. In at least one aspect, the flow shaper 310 may be readily replaceable since it will have a minimal amount of activation.

Traditionally, walls within generic reactors are formed of materials that may stand up to reactor conditions, such as tungsten (W) or molybdenum (Mo). However, because the neutron absorption cross-sections of tungsten and molybdenum are approximately 10⁻² barns, walls formed of these materials may parasitically absorb neutrons resulting in inadequate tritium production necessary for the reactor to be self-sustaining. Thus, in at least one aspect, the flow shaper 310 of the fusion reactor 300 may be formed of a low fast neutron absorbing material. For example, carbon (C) includes a neutron absorption cross-section of approximately 10⁻⁴ barns. As such, in one or more aspects, the flow shaper 310 of the fusion reactor 300 may be formed of carbon, graphite, or an equivalent low fast neutron absorbing material.

Further to the above, the thickness of the flow shaper 310 may be based at least in part on the expected fusion reaction within the fusion reactor 300. That is, the thickness of the flow shaper 310 may be a minimal thickness required to withstand any shock waves generated by the fusion reaction of the fusion reactor 300. Further, the determination of the minimal thickness of the flow shaper 310 may consider that any shock wave generated by the fusion reaction may be reduced by the coolant 305 flowing over the interior of the flow shaper 310.

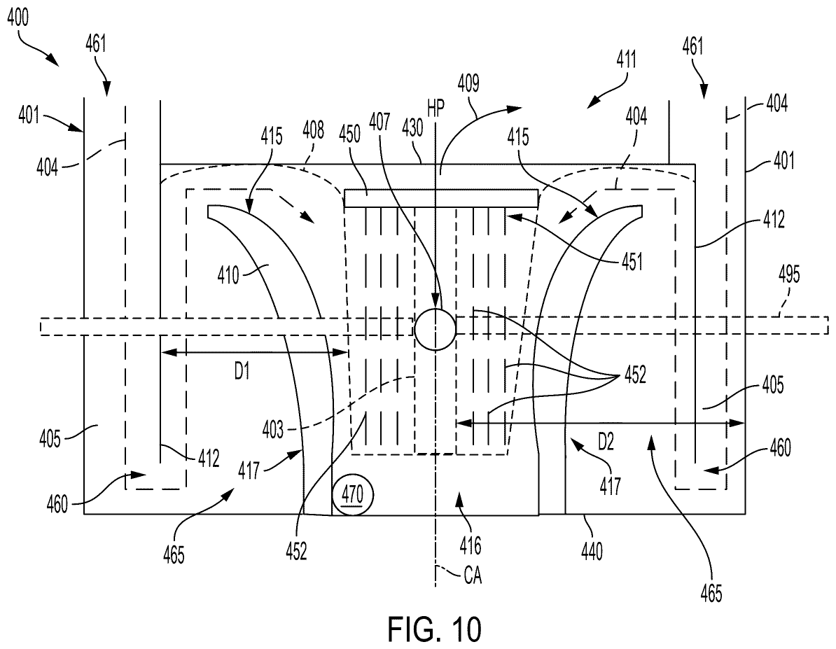

FIG. 10 illustrates an additional embodiment of an inertial confinement fusion reactor 400 comprising a flow shaper 410 (e.g., a funnel portion or a reactor vessel interior structure) configured to shape a flow 404 of coolant 405 within a chamber 411. The chamber 411 comprises an upper plate 430, a lower plate 440, and a chamber wall 412 extending between the upper plate 430 and the lower plate 440. The fusion reactor 400 defines a central axis CA as shown in FIG. 10.

Further to the above, the fusion reactor 400 comprises a coolant inlet 460 defined in the chamber wall 412 and a coolant outlet 470 at a lower portion of the fusion reactor 400. In at least one embodiment, the coolant inlet 460 may be an annular opening defined in the chamber wall 412. In use, the coolant 405 enters the chamber 411 through the coolant inlet 460 and fills a reservoir 465 defined between an outer surface 417 of the flow shaper 410 and the chamber wall 412. In other words, the coolant inlet 460 receives and directs the coolant 405 into the reservoir 465. The inlet 460 may be positioned at any height along the chamber wall 412. In addition, coolant 405 may be provided to the inlet 460 via a downcomer, or inlet channel 461. In at least one embodiment, the inlet channel 461 may be an opening defined between a reactor wall, or outer wall 401, and the chamber wall 412. In one embodiment, the inlet channel 461 may be annular in shape. In the non-limiting example of FIG. 10, the fusion reactor 400 includes the inlet channel 461 surrounding the chamber wall 412. In this example, the flow 404 of the coolant 405 travels downward through the inlet channel 461 and enters the chamber 411 through the inlet 460 provided along a lower end of the chamber wall 412.

In at least one aspect, the coolant 405 is introduced to the inlet channel 461 or to the chamber 411 through the inlet 460 in a tangential manner. In another aspect, the coolant 405 is introduced to the inlet channel 461 or to the chamber 411 under normal flow conditions (e.g., non-tangential). In any event, upon entering the chamber 411 through the inlet 460, the coolant 405 fills the reservoir 465 between the chamber wall 412 and the flow shaper 410. As coolant 405 is continually supplied to the chamber 411, a level of the coolant 405 in the reservoir 465 increases such that the coolant 405 overflows the top end of the flow shaper 410 onto an interior surface 415 of the flow shaper 410. Further, as the reactor coolant 405 overflows the top end of the flow shaper 410, the coolant 405 flows along the interior surface 415 of the flow shaper 410 and eventually exits the flow shaper 410 through the coolant outlet 470 at the bottom of the chamber 411.

In one aspect, after overflowing the top end of the flow shaper 410, the coolant 405 flows in a centrifugal manner and downward along the entire height of the interior surface 415 of the flow shaper 410 until the coolant 405 exits through the coolant outlet 470. In at least one aspect, the coolant 405 is evenly distributed as centrifugal flow onto the interior surface 415 of the flow shaper 410 after overflowing the top end of the flow shaper 410.

In an alternative aspect, after overflowing the top end of the flow shaper 410, the coolant 405 flows in linearly and downward along the entire height of the interior surface 415 of the flow shaper 410 until the coolant 405 exits through the coolant outlet 470. In at least one aspect, the coolant 405, flowing linearly, is evenly distributed onto the interior surface 415 of the flow shaper 410 after overflowing the top end of the flow shaper 410. In one embodiment, the flow of the coolant 405 along the interior surface 415 is a thin layered flow. The thickness and flow rate of the thin layer of flow may be determined based on the amount of heat which must be removed due to the fusion reaction.

In at least one aspect, the reactor 400 further includes a second coolant inlet or coolant distributor 450. The coolant distributor 450 is configured to emit, or dispense, a second reactor coolant 451 in a plurality of predefined streams 452 such that a central void region 403 is defined between the plurality of predefined streams 452. In one embodiment, the coolant distributor 450 includes a plurality of nozzles which emit the second reactor coolant 451. In one embodiment, the predefined streams 452 free fall from the coolant distributor 450 due to gravity. In another embodiment, the predefined streams 452 are propelled from the coolant distributor 450 toward the bottom of the chamber 411. For example, the second coolant 451 may be pressurized such that the second coolant 451 is propelled from the coolant distributor 450 with an amount of force in addition to gravity. Further, as shown in FIG. 10, the central void region 403 is positioned beneath the coolant distributor 450 and at least partially within an interior region 416 defined by the flow shaper 410. In one embodiment, the plurality of predefined streams 452 are positioned in a circular perimeter about the central axis CA of the fusion reactor 400 such that the central void region 403 is a cylindrical void region defined between the plurality of predefined streams 452. The circular perimeter may be such that the plurality of predefined streams 452 are positioned completely around (e.g., in a three hundred and sixty degree envelope) the central axis CA of the reactor 400.

In one embodiment, the first coolant 405 and the second coolant 451 are the same type of coolant. In an alternative embodiment, the first coolant 405 and the second coolant 451 are different types of coolant. In one embodiment, the first coolant 405 and/or the second coolant 451 comprises lithium. In another embodiment, the first coolant 405 and/or the second coolant 451 comprises lead and lithium. In some embodiments, the first coolant 405 and/or the second coolant 451 comprises FLiBe (Li2BeF4). In various embodiments, the first coolant 405 and/or the second coolant 451 comprise one of lithium, a combination of lead and lithium, FLiBe, or a combination thereof.

Further to the above, the fusion reactor 400 further comprises a Hohlraum injector to inject a Hohlraum pellet (e.g., a fuel pellet) into the central void region 403 within the plurality of predefined reactor coolant streams 452. In at least one aspect, the Hohlraum injector is housed within and/or injects the pellet through the coolant distributor 450 in the direction of arrow HP shown in FIG. 10. Further, the fusion reactor 400 may include a plurality of laser beam injector ports 495 that permit a plurality of lasers disposed exterior to the chamber 411 to direct energy through the laser beam injector ports 495 at the pellet when the pellet is injected into the central void region 403. In at least one aspect, the laser beam injector ports 495 may extend horizontally and be positioned at a height similar to the pellet such that energy from the lasers may be directed horizontally at the pellet. In at least one aspect, the laser beam injector ports 495 may extend vertically or diagonally towards the pellet. In at least one aspect, the laser beam injector ports 495 may extend through the flow shaper 410, the chamber wall 412, and/or the inlet channel 461. In any event, the lasers direct energy through the laser beam injector ports 495 to intercept the injected pellet from the Hohlraum injector as the pellet falls into the paths of the laser beam injector ports 495. Upon the laser beams intercepting the pellet, a fusion reaction begins within the central void region 403. The fusion reaction is represented by a reaction zone 407 illustrated in FIG. 10. In at least one aspect, when a fusion reaction is sustained in the reaction zone 407, a liquid gas interface 408 forms between the reactor coolant 405, 451 and exhaust gasses 409 in the fusion reactor 400.

In use, during the fusion reaction, the coolant 405 flowing along the interior surface 415 of the flow shaper 410 and the coolant streams 452 flowing from the coolant distributor 450 may intercept some of the neutrons emitted from the reaction zone 407. The coolant pool of reactor coolant 405 within the reservoir 465 is to absorb the bulk of the neutrons emitted from the reaction zone 407 to prevent the chamber wall 412 from absorbing the neutrons. The width of the chamber 411, and thus the amount of coolant 405 between the reaction zone 407 and/or the central void region 403 and the chamber wall 412 can be optimized to prevent the neutrons produced by the fusion reaction from reaching the chamber wall 412. That is, in at least one aspect, the distance D1 from the chamber wall 412 to the reaction zone 407 and/or the central void region 403 may be equal to or greater than a minimum thickness of the reactor coolant 405 required to absorb the neutrons produced from the reaction zone 407 such that the neutrons produced are prevented from being absorbed by the chamber wall 412. In at least one aspect, the distance D1 may be selected such that the thickness of the coolant 405 positioned in the reservoir 465 is sufficient to prevent neutrons from being absorbed by the chamber wall 412.

In at least one aspect, the reactor 400 may include the outer wall 401, positioned around the chamber wall 412. In such an instance, as depicted in FIG. 10, the distance D2 from the outer wall 401 to the reaction zone 407 and/or the central void region 403 may be equal to or greater than a minimum thickness of the reactor coolant 405 required to absorb the neutrons produced from the reaction zone 407 such that the neutrons produced are prevented from being absorbed by the outer wall 401. In at least one aspect, the distance D2 may be selected such that, the thickness of the coolant 405 within the reservoir 465 and the thickness of coolant 405 within the inlet channel 461 is sufficient to prevent any neutrons from reaching the outer wall 401. In at least one aspect, the outer wall 401 may be a minimum thickness required to prevent neutrons from the reaction zone 407 from passing therethrough.

Further to the above, during the fusion reaction, the reaction zone 407 may emit gamma x-rays and debris. The plurality of predefined streams 452 are to absorbs the gamma x-rays and the debris from the reaction zone 407 during the fusion reaction and the streams 452 may also absorb some of amount of the neutrons emitted. However, as discussed above, the bulk of the emitted neutrons are to be absorbed by the coolant 405 within the reservoir 465 and/or the coolant 405 in the inlet channel 461, if present. Further during the fusion reaction, the plurality of predefined streams 452 flowing from the coolant distributor 450 will be vaporized, or exploded, from the energy of the fusion reaction coming from the reaction zone 407. As adjacent streams 452 explode against adjacent streams, the forces from these explosions will substantially, or completely, offset each other owing to the positioning of the streams (e.g., surrounding the reaction zone 407 three hundred and sixty degrees on all sides). In other words, the shockwave produced from a given exploding stream will be canceled out, or at least substantially canceled out, by an equal and opposite shockwave produced from an opposingly positioned stream. As such, the forces from the exploding streams balance each other and, thus, prevent large shockwave forces from being applied to the flow shaper 410 and/or the chamber wall 412.

Further to the above, unlike the chamber wall 412, the flow shaper 410 may not be considered as a structural member of the fusion reactor 400 (i.e., providing structural support). As such, the flow shaper 410 may be formed of a material that is lighter and/or thinner than structural members of generic reactors. In at least one aspect, the material of the flow shaper 410 may also include a low neutron absorption coefficient to minimize parasitic neutron absorption and activation. In at least one aspect, the flow shaper 410 may be readily replaceable since it will have a minimal amount of activation.

Traditionally, walls within generic reactors are formed of materials that may stand up to reactor conditions, such as tungsten (W) or molybdenum (Mo). However, because the neutron absorption cross-sections of tungsten and molybdenum are approximately 10⁻² barns, walls formed of these materials may parasitically absorb neutrons resulting in inadequate tritium production necessary for the reactor to be self-sustaining. Thus, in at least one aspect, the flow shaper 410 of the fusion reactor 400 may be formed of a low fast neutron absorbing material. For example, carbon (C) includes a neutron absorption cross-section of approximately 10⁻⁴ barns. As such, in one or more aspects, the flow shaper 410 of the fusion reactor 400 may be formed of carbon, graphite, or an equivalent low fast neutron absorbing material.

Further to the above, the thickness of the flow shaper 410 may be based at least in part on the expected fusion reaction within the fusion reactor 400. That is, the thickness of the flow shaper 410 may be a minimal thickness required to withstand any shock waves generated by the fusion reaction and not absorbed by the streams 452 of the fusion reactor 400. As such, in the event a shock wave is not canceled out by an opposing shockwave, as discussed above, the flow shaper 410 may withstand the break through shock wave. Further, the determination of the minimal thickness of the flow shaper 410 may consider that any shock wave generated by the fusion reaction may be reduced by the coolant 405, 451 flowing around the reaction zone 407 and/or may be reduced by opposing shock waves due to the positioning of the predefined coolant streams 452.

Various aspects of the present disclosure include, but are not limited to, the aspects listed in the following numbered clauses.

Clause 1—An inertial confinement fusion reactor comprising a chamber, a first coolant inlet, a coolant outlet, a flow shaper, and a second coolant inlet. The chamber having a chamber wall extending between an upper plate and a lower plate. The first coolant inlet is defined in the chamber wall. The flow shaper is disposed within the chamber. The flow shaper defines an interior region and the coolant outlet is positioned within the interior region. The first coolant inlet is configured to receive and direct a first coolant into a reservoir defined between the chamber wall and an outer surface defined by the flow shaper. The first coolant is to overflow a top end of the flow shaper, flow along an inner surface defined by the flow shaper, and exit the reactor through the coolant outlet. The second coolant inlet is configured to dispense a second coolant in a plurality of predefined streams such that a central void region is defined between the plurality of predefined streams, the central void region positioned beneath the second coolant inlet and at least partially within the interior region defined by the flow shaper. The second coolant is to exit the reactor through the coolant outlet.

Clause 2—The inertial confinement fusion reactor of clause 1, wherein the plurality of predefined streams are positioned in a circular perimeter about a central axis of the reactor such that the central void region is a cylindrical void region defined between the plurality of predefined streams.

Clause 3—The inertial confinement fusion reactor of clause 1 or 2, wherein the first coolant and the second coolant are the same.

Clause 4—The inertial confinement fusion reactor of clause 1 or 2, wherein the first coolant and the second coolant are different.

Clause 5—The inertial confinement fusion reactor of clauses 1, 2, 3, or 4 wherein a distance between the chamber wall to the central void region is equal to or greater than a minimum coolant thickness of the first coolant required to prevent the chamber wall from absorbing neutrons produced during a fusion reaction within the central void region.

Clause 6—The inertial confinement fusion reactor of clauses 1, 2, 3, 4, or 5 wherein one of the first coolant or the second coolant comprises lithium.

Clause 7—The inertial confinement fusion reactor of clauses 1, 2, 3, 4, 5, or 6 wherein one of the first coolant or the second coolant comprises lead and lithium.

Clause 8—The inertial confinement fusion reactor of clauses 1, 2, 3, 4, 5, 6, or 7, wherein one of the first coolant or the second coolant comprises FLiBe (Li2BeF4).

Clause 9—The inertial confinement fusion reactor of clauses 1, 2, 3, 4, 5, 6, 7, or 8, further comprising an outer wall positioned around the chamber wall, wherein a downcomer is defined between the outer wall and the chamber wall, the first coolant inlet to receive the first coolant from the downcomer.

Clause 10—The inertial confinement fusion reactor of clause 9, wherein a distance between the outer wall to the central void region is equal to or greater than a minimum thickness of the first coolant required to prevent the outer wall from absorbing neutrons produced during a fusion reaction within the central void region.

Clause 11—An inertial confinement fusion reactor comprising a chamber, a coolant inlet, a coolant outlet, a flow shaper, and a coolant distributor. The chamber having a chamber wall extending between an upper plate and a lower plate, the coolant inlet defined in the chamber wall. The flow shaper is disposed within the chamber. The flow shaper defines an interior region, and the coolant outlet is positioned within the interior region. The coolant inlet is configured to receive and direct reactor coolant into a reservoir defined between the chamber wall and an outer surface defined by the flow shaper. The reactor coolant is to overflow a top end of the flow shaper, flow along an inner surface defined by the flow shaper, and exit the reactor through the coolant outlet. The coolant distributor is configured to dispense reactor coolant in a plurality of predefined streams such that a central void region is defined between the plurality of predefined streams, the central void region positioned beneath the coolant distributor and at least partially within the interior region defined by the flow shaper. The reactor coolant flowing from the coolant distributor exits the reactor through the coolant outlet.

Clause 12—The inertial confinement fusion reactor of clause 11, wherein the plurality of predefined streams are positioned in a circular perimeter about a central axis of the reactor such that the central void region is a cylindrical void region defined between the plurality of predefined streams.

Clause 13—The inertial confinement fusion reactor of clause 11 or 12, wherein a distance between the chamber wall to the central void region is equal to or greater than a minimum thickness of the reactor coolant required to prevent the chamber wall from absorbing neutrons produced during a fusion reaction within the central void region.

Clause 14—The inertial confinement fusion reactor of clauses 11, 12, or 13, wherein the reactor coolant comprises one of lithium, a combination of lead and lithium, FLiBe (Li2BeF4), or combinations thereof.

Clause 15—The inertial confinement fusion reactor of clauses 11, 12, 13, or 14, further comprising an outer wall positioned around the chamber wall, wherein a downcomer is defined between the outer wall and the chamber wall, the coolant inlet to receive the reactor coolant from the downcomer.

Clause 16—The inertial confinement fusion reactor of clause 15, wherein a distance between the outer wall to the central void region is equal to or greater than a minimum thickness of the reactor coolant required to prevent the outer wall from absorbing neutrons produced during a fusion reaction within the central void region.

Clause 17—An inertial confinement fusion reactor comprising a chamber, a flow shaper, a coolant inlet, and a coolant distributor. The chamber comprising a chamber wall extending between an upper plate and a lower plate. The flow shaper is disposed within the chamber, the flow shaper defining an interior region. The coolant inlet is to receive and direct reactor coolant into a reservoir defined between the chamber wall and an outer surface of the flow shaper. The reactor coolant is configured to overflow the flow shaper and flow along an interior surface of the flow shaper to a coolant outlet positioned within the interior region. The coolant distributor is configured to dispense reactor coolant in a plurality of predefined streams such that a central void region is defined between the plurality of predefined streams, the central void region positioned beneath the coolant distributor and at least partially within the interior region defined by the flow shaper. The reactor coolant flowing from the coolant distributor exits the reactor through the coolant outlet.

Clause 18—The inertial confinement fusion reactor of clause 17, wherein the plurality of predefined streams are positioned in a circular perimeter about a central axis of the reactor such that the central void region is a cylindrical void region defined between the plurality of predefined streams.

Clause 19—The inertial confinement fusion reactor of clause 17 or 18, wherein a distance between the chamber wall to the central void region is equal to or greater than a minimum thickness of the reactor coolant required to prevent the chamber wall from absorbing neutrons produced during a fusion reaction within the central void region.

Clause 20—The inertial confinement fusion reactor of clauses 17, 18, or 19, wherein the reactor coolant comprises one of lithium, a combination of lead and lithium, FLiBe (Li2BeF4), or combinations thereof.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. An inertial confinement fusion reactor, comprising:
a chamber comprising a chamber wall extending between an upper plate and a lower plate;
a first coolant inlet defined in the chamber wall;
a coolant outlet;
a flow shaper disposed within the chamber, the flow shaper defining an interior region, the coolant outlet positioned within the interior region, wherein the first coolant inlet is configured to receive and direct a first coolant into a reservoir defined between the chamber wall and an outer surface defined by the flow shaper, and wherein the first coolant is to overflow a top end of the flow shaper, flow along an inner surface defined by the flow shaper, and exit the reactor through the coolant outlet; and
a second coolant inlet configured to dispense a second coolant in a plurality of predefined streams such that a central void region is defined between the plurality of predefined streams, the central void region positioned beneath the second coolant inlet and at least partially within the interior region defined by the flow shaper, wherein the second coolant is to exit the reactor through the coolant outlet.

2. The inertial confinement fusion reactor of claim 1, wherein the plurality of predefined streams are positioned in a circular perimeter about a central axis of the reactor such that the central void region is a cylindrical void region defined between the plurality of predefined streams.

3. The inertial confinement fusion reactor of claim 1, wherein the first coolant and the second coolant are the same.

4. The inertial confinement fusion reactor of claim 1, wherein the first coolant and the second coolant are different.

5. The inertial confinement fusion reactor of claim 1, wherein a distance between the chamber wall to the central void region is equal to or greater than a minimum coolant thickness of the first coolant required to prevent the chamber wall from absorbing neutrons produced during a fusion reaction within the central void region.

6. The inertial confinement fusion reactor of claim 1, wherein one of the first coolant or the second coolant comprises lithium.

7. The inertial confinement fusion reactor of claim 1, wherein one of the first coolant or the second coolant comprises lead and lithium.

8. The inertial confinement fusion reactor of claim 1, wherein one of the first coolant or the second coolant comprises FLiBe (Li₂BeF₄).

9. The inertial confinement fusion reactor of claim 1, further comprising an outer wall positioned around the chamber wall, wherein a downcomer is defined between the outer wall and the chamber wall, the first coolant inlet to receive the first coolant from the downcomer.

10. The inertial confinement fusion reactor of claim 9, wherein a distance between the outer wall to the central void region is equal to or greater than a minimum thickness of the first coolant required to prevent the outer wall from absorbing neutrons produced during a fusion reaction within the central void region.

11. An inertial confinement fusion reactor, comprising:
a chamber comprising a chamber wall extending between an upper plate and a lower plate;
a coolant inlet defined in the chamber wall;
a coolant outlet;
a flow shaper disposed within the chamber, the flow shaper defining an interior region, the coolant outlet positioned within the interior region, wherein the coolant inlet is configured to receive and direct reactor coolant into a reservoir defined between the chamber wall and an outer surface defined by the flow shaper, and wherein the reactor coolant is to overflow a top end of the flow shaper, flow along an inner surface defined by the flow shaper, and exit the reactor through the coolant outlet; and
a coolant distributor configured to dispense reactor coolant in a plurality of predefined streams such that a central void region is defined between the plurality of predefined streams, the central void region positioned beneath the coolant distributor and at least partially within the interior region defined by the flow shaper, wherein the reactor coolant flowing from the coolant distributor exits the reactor through the coolant outlet.

12. The inertial confinement fusion reactor of claim 11, wherein the plurality of predefined streams are positioned in a circular perimeter about a central axis of the reactor such that the central void region is a cylindrical void region defined between the plurality of predefined streams.

13. The inertial confinement fusion reactor of claim 11, wherein a distance between the chamber wall to the central void region is equal to or greater than a minimum thickness of the reactor coolant required to prevent the chamber wall from absorbing neutrons produced during a fusion reaction within the central void region.

14. The inertial confinement fusion reactor of claim 11, wherein the reactor coolant comprises one of lithium, a combination of lead and lithium, FLiBe (Li₂BeF₄), or combinations thereof.

15. The inertial confinement fusion reactor of claim 11, further comprising an outer wall positioned around the chamber wall, wherein a downcomer is defined between the outer wall and the chamber wall, the coolant inlet to receive the reactor coolant from the downcomer.

16. The inertial confinement fusion reactor of claim 15, wherein a distance between the outer wall to the central void region is equal to or greater than a minimum thickness of the reactor coolant required to prevent the outer wall from absorbing neutrons produced during a fusion reaction within the central void region.

17. An inertial confinement fusion reactor, comprising:
a chamber comprising a chamber wall extending between an upper plate and a lower plate;
a flow shaper disposed within the chamber, the flow shaper defining an interior region;
a coolant inlet to receive and direct reactor coolant into a reservoir defined between the chamber wall and an outer surface of the flow shaper, wherein the reactor coolant is configured to overflow the flow shaper and flow along an interior surface of the flow shaper to a coolant outlet positioned within the interior region; and
a coolant distributor configured to dispense reactor coolant in a plurality of predefined streams such that a central void region is defined between the plurality of predefined streams, the central void region positioned beneath the coolant distributor and at least partially within the interior region defined by the flow shaper, wherein the reactor coolant flowing from the coolant distributor exits the reactor through the coolant outlet.

18. The inertial confinement fusion reactor of claim 17, wherein the plurality of predefined streams are positioned in a circular perimeter about a central axis of the reactor such that the central void region is a cylindrical void region defined between the plurality of predefined streams.

19. The inertial confinement fusion reactor of claim 17, wherein a distance between the chamber wall to the central void region is equal to or greater than a minimum thickness of the reactor coolant required to prevent the chamber wall from absorbing neutrons produced during a fusion reaction within the central void region.

20. The inertial confinement fusion reactor of claim 17, wherein the reactor coolant comprises one of lithium, a combination of lead and lithium, FLiBe (Li₂BeF₄), or combinations thereof.
